(19) United States
(12) Patent Application Publication
(10) Pub. No.: US 2018/0172986 A1
(43) Pub. Date: Jun. 21, 2018

(54) Camera Lens Assembly

(71) Applicant: Robert Bosch LLC, Broadview, IL (US)

(72) Inventor: Ligor Manushi, Northville, MI (US)

(73) Assignee: Robert Bosch GmbH, Stuttgart (DE)

(21) Appl. No.: 15/381,583

(22) Filed: Dec. 16, 2016

(51) Int. Cl. G02B 27/00; G02B 9/60; H04N 5/225; G02B 7/02; B60R 1/00

(52) U.S. Cl. CPC G02B 27/0006; G02B 9/60; B60R 1/00; H04N 5/2254; G02B 7/021; H04N 5/2252

(57) ABSTRACT

A lens assembly for a near range camera includes a lens stack diposed in a tubular lens housing. The lens stack includes several lenses in a stacked arrangement. An outermost lens of the lens stack is disposed in an open end of the lens housing, and a second lens of the lens stack abuts an inward facing surface of the outermost lens along an annular region of contact between the outermost lens and the second lens. A seal is provided along the annular region of contact. In some embodiments, the seal is formed by fusing the first lens to the second lens along the annular region of contact.

### BACKGROUND

Near range automotive cameras can be used individually or in combination with other cameras to monitor the environment outside a vehicle. In some automotive camera systems, several near range cameras are placed around the vehicle. For example, one camera is directed forward, another camera is directed rearward, and two side cameras are integrated into the vehicle exterior rear-view mirrors. For cameras each having an aperture of 190 degrees, the vehicle's entire surroundings are captured. The camera system also includes an ECU, which merges the camera images to form a 360-degree view and may combine them with distance information from ultrasonic sensors. This data can be used to generate a dynamic 3D images that represent objects in the vicinity of the vehicle.

Automotive cameras are subject to high mechanical stresses, considerable temperature fluctuations, and to the effects of moisture. When a camera that does not have a completely impervious design is used under the climatic conditions typical of automotive applications, this can lead to moisture condensation in the optical path. This in turn leads to degradation of the image quality. Moisture condensation is often observed when a high relative air humidity has set in inside of the camera for a length of time at elevated temperatures, and the camera is then cooled within a short period of time.

Autonomous vehicle technology is one example of an area in which the image quality obtained by a near range camera can be critical to safe operation of the technology. Thus it is desirable to provide automotive cameras having lens assemblies that have improved imperviousness to moisture penetration.

### SUMMARY

In some aspects, a camera lens assembly includes a lens housing having an open end, and a lens stack disposed in the lens housing, The lens stack includes a first lens disposed in the lens housing open end. The first lens provides an outermost lens of the lens stack and includes a first outward facing surface, a first inward facing surface that is spaced apart from the first outward facing surface, and a first peripheral edge that extends between the first outward facing surface and the first inward facing surface. The lens stack includes a second lens disposed in the lens housing. The second lens includes a second outward facing surface, a second inward facing surface that is spaced apart from the second outward facing surface, and a second peripheral edge that extends between the second outward facing surface and the second inward facing surface. The second outward facing surface faces the first inward facing surface. The camera lens assembly further includes a lens seal disposed between the second outward facing surface and the first inward facing surface.

The camera lens assembly may include one or more of the following features: A portion of the second outward facing surface abuts a portion of the first inward facing surface so as to form an annular region of contact between the first lens and the second lens; and the lens seal is a fusion of the first lens with the second lens along the annular region of contact. The lens seal is an annular gasket disposed between the first lens and the second lens. The camera lens assembly includes a first annular housing seal disposed between the first peripheral edge and an inner surface of the lens housing. The lens housing comprises a first end that defines the open end, a second end opposed to the first end, and a non-uniform inner diameter such that a shoulder is disposed between the first end and the second end. In addition, the second inward facing surface is supported on the shoulder, and the first annular housing seal is disposed between the first peripheral edge and an inner surface of the lens housing at a location between the first end and the shoulder. The lens stack includes n lenses, where n is a positive integer have a value of at least four. The first inward facing surface is convex, the second outward facing surface is planar, and a first sealed space exists between the first inward facing surface, the lens seal, and the second outward facing surface. The first lens and the second lens are each formed of glass. The first lens is formed of glass and the second lens is formed of plastic.

In some aspects, a camera includes a camera housing having an opening, and a lens stack disposed in the opening. The lens stack includes a first lens that provides an outermost lens of the lens stack. The first lens includes a first outward facing surface, a first inward facing surface spaced apart from the first outward facing surface, and a first peripheral edge that extends between the first outward facing surface and the first inward facing surface. The lens stack includes a second lens that has a second outward facing surface, a second inward facing surface spaced apart from the second outward facing surface, and a second peripheral edge that extends between the second outward facing surface and the second inward facing surface. The second outward facing surface faces the first inward facing surface. The camera further includes an annular housing seal disposed between the first lens and the camera housing, and a lens seal disposed between the second outward facing surface and the first inward facing surface.

The camera may include one or more of the following features: A portion of the second outward facing surface abuts a portion of the first inward facing surface so as to form an annular region of contact between the first lens and the second lens; and the lens seal is a fusion of the first lens with the second lens along the annular region of contact. The lens seal is an annular gasket disposed between the first lens and the second lens. The camera includes a lens housing disposed in the opening and protruding outward from the camera housing, and the lens stack is disposed in the lens housing with the first outward facing surface disposed in an open end of the lens housing. The annular housing seal is disposed between the first peripheral edge and an inner surface of the lens housing. The lens housing includes a first end that defines the open end, a second end opposed to the first end, and a non-uniform inner diameter such that a shoulder is disposed between the first end and the second end. The second inward facing surface is supported on the shoulder, the annular housing seal is disposed between the first peripheral edge and an inner surface of the lens housing at a location between the first end and the shoulder, and a second annular housing seal is disposed between the shoulder and the camera housing. The lens stack includes n lenses, where n is a positive integer have a value of at least four. The first lens and the second lens are each formed of glass. The first lens is formed of glass and the second lens is formed of plastic.

In some embodiments, a lens assembly for a near range camera includes a lens stack diposed in a tubular lens housing. The lens stack includes several lenses in a stacked arrangement. An outermost lens of the lens stack is disposed in an open end of the lens housing, and a second lens of the lens stack is fused to an inward facing surface of the outermost lens along an annular region of contact between the outermost lens and the second lens. Fusing the outermost lens and the second lens together along an annular region of contact has several benefits. For example, moisture is prevented from permeating into the space betwen the outermost lens and the second lens since this space is surrounded by the annular fused region. This is particularly effective if the outermost lens and second lens are formed of glass rather than plastic, since the moisture permeation rate of glass is much less than that of plastic. For example, at 25 degrees Celcius, the diffusion coefficient of moisture into glass is more than 10⁶ times that of plastic.

Another benefit of fusing the outermost lens and the second lens together along an annular region of contact is related to the fact that the trapped air volume in the space defined between the outermost lens, the second lens, and the annular fused region is much smaller than trapped air volume in some conventional lens assemblies in which a seal is provided between a periphery of the outermost lens and the lens housing. Since the trapped air volume is much smaller, the amount of moisture available for condensation in the space is also much smaller. In another example, by fusing the outermost lens of the stack to the second lens, moisture within the camera body is prevented from entering the space, as is moisture that permeates the tubular lens housing and camera housing, which are frequently formed of plastic.

Yet another benefit of fusing the outermost lens and the second lens together along an annular region of contact is related to the fact that the contact surface is shifted from the outermost lens to an inner lens, e.g., the second lens. Since the second lens does not come into contact with the outside environment, moisture condensation at the second lens is unlikely.

In some embodiments, seals are provided between selected lenses of the lens stack and the lens housing to prevent moisture from entering the camera housing. In addition, by placement at strategic locations between selected lenses of the lens stack and the lens housing, the air volume between the outermost lens and the second lens can be isolated from the interior space of the camera housing and any moisture it contains.

### BRIEF DESCRIPTION OF THE DRAWINGS

FIG. 1 is a perspective view of a near range automotive camera.

FIG. 2 is a cross sectional view of the camera of FIG. 1 illustrating a lens assembly.

FIG. 3 is a cross sectional view of the first (outermost) and second lenses shown isolated from the lens assembly.

FIG. 4 is an end view of the first (outermost) lens as seen along line 4-4 of FIG. 3.

FIG. 5 is a cross sectional view of the camera of FIG. 1 illustrating an alternative lens assembly.

### DETAILED DESCRIPTION

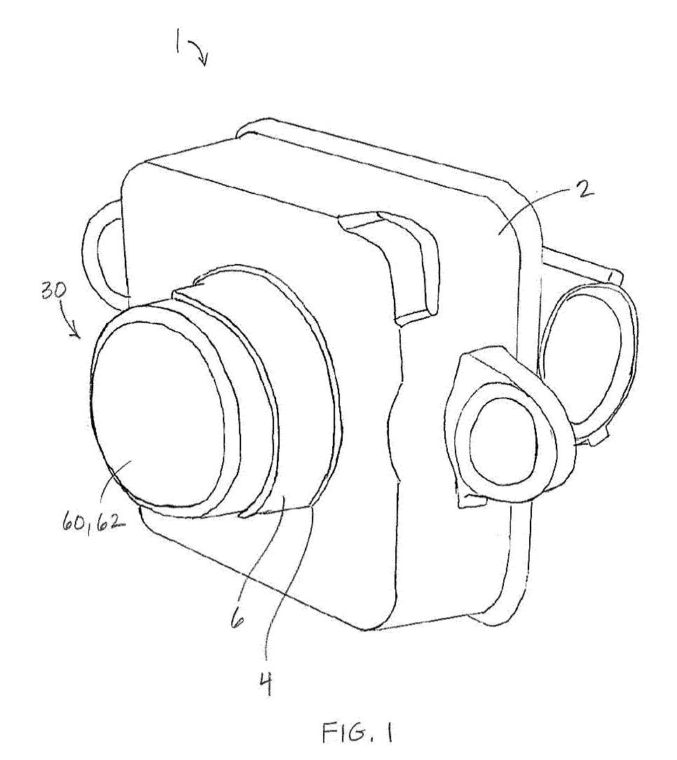

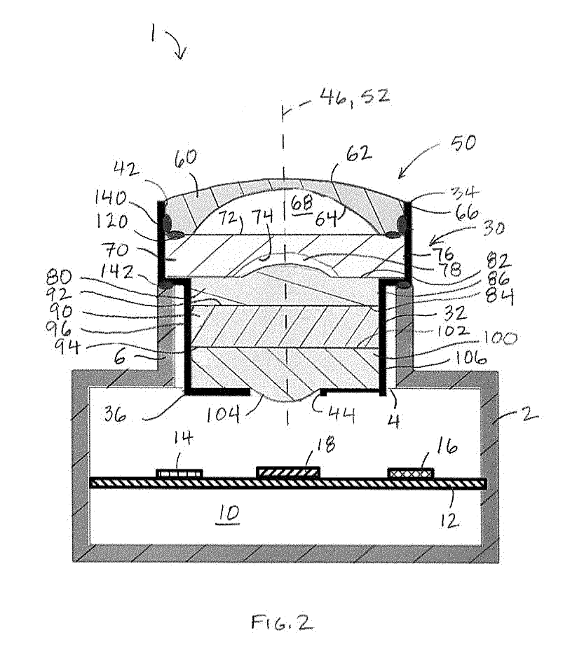

Referring to FIGS. 1 and 2, an automotive camera system used to monitor the environment of a vehicle may include one or more cameras. In some embodiments, the camera system includes at least one near range camera 1. The near range camera 1 includes a camera housing 2 that supports and protects a lens assembly 30, a printed circuit board (PCB) 12, and various electronic components that are disposed on the PCB 12. The electronic components may include, for example, an electronic control unit 14, memory 16, an image sensor 18 and other ancillary components used to operate the camera 1, store detected images and transfer information to and from the camera 1. Information may be transferred to and from the camera 1 via a wired connection (not shown) and/or wirelessly. The camera housing 2 defines an interior space 10, and includes an opening 4 that is aligned with the image sensor 18, and a tubular collar 6 surrounds the opening 4. The collar 6 protrudes outward from an outer surface of the camera housing 2 in a direction normal to the outer surface. The lens assembly 30 is supported within the collar 6 so as to be fixed relative to the camera housing 2 and so that an optical axis 52 of the lens assembly 30 intersects the image sensor 18, as discussed in detail below.

The lens assembly 30 includes a lens housing 32 that supports a lens stack 50 relative to the camera housing 2 and the image sensor 18. The lens housing 32 is a cylindrical tube having an open first end 34, a second end 36 opposed to the first end, and a longitudinal axis 46 extending between the first and second ends 34, 36. The lens housing 32 has a non-uniform diameter such that a diameter of the first end 34 is greater than a diameter of the second end 36, and a shoulder 40 is disposed between the first end 34 and the second end 36. In particular, the diameter of the first end 34 corresponds to an outer diameter of the collar 6, and the diameter of the second end 36 is less than an inner diameter of the collar 6. The second end 36 of the lens housing 32 is shaped and dimensioned to fit within the collar 6, and includes a central opening 44 through which light passes into the camera housing 2. The lens housing 32 is partially received within the collar 6 such that the second end 36 resides within the camera housing opening 4, and the shoulder 40 is supported on a terminal end of the collar 6. In addition, the first end 34 of the lens housing 32 resides outside the camera housing 2.

The lens stack 50 is disposed in and surrounded by the lens housing 32. In the illustrated embodiment, the lens stack 50 includes five individual lenses 60, 70, 80, 90, 100 in a stacked arrangement. In particular, the five lenses 60, 70, 80, 90, 100 are arranged such that an optical axis of each lens, and thus also an optical axis 52 of the lens stack 50, coincides with the longitudinal axis 46 of the lens housing 32.

The lens stack 50 includes a first lens 60 disposed in the lens housing open first end 34. The first lens 60 is an outermost lens of the lens stack 50, and includes a first outward facing surface 62, a first inward facing surface 64 that is spaced apart from the first outward facing surface 62, and a first peripheral edge 66 that extends between the first outward facing surface 62 and the first inward facing surface 64. The first lens 60 is a meniscus lens, and thus the first outward facing surface 62 is outwardly convex and the first inward facing surface 64 is concave. The radius of curvature of the first outward facing surface 62 is greater than the radius of curvature of the first inward facing surface.

The second lens 70 is disposed in the lens housing 32 adjacent to the first lens 60. The second lens 70 includes a second outward facing surface 72 that faces the first inward facing surface 64, a second inward facing surface 74 that is spaced apart from the second outward facing surface 72, and a second peripheral edge 76 that extends between the second outward facing surface 72 and the second inward facing surface 74. The second lens 70 is a piano-concave lens, and thus the second outward facing surface 72 is planar, and the second inward facing surface 74 is concave. The radius of curvature of the first inward facing surface 64 is greater than the radius of curvature of the second inward facing surface 74.

A space 68 exists between the curved first inward facing surface 64 and the planar second outward facing surface 72. In some conventional near range cameras, an in certain operating conditions, undesirable condensation of moisture within the space 68 on the first inward facing surface 64 has been known to occur. The camera 1 includes sealing features which minimize the possibility of such condensation, as will be discussed in detail below.

The third lens 80 is disposed in the lens housing 32 adjacent to the second lens 70. The third lens 80 includes a third outward facing surface 82 that faces and abuts the second inward facing surface 74, a third inward facing surface 84 that is spaced apart from the third outward facing surface 82, and a third peripheral edge 86 that extends between the third outward facing surface 82 and the third inward facing surface 84. The third lens 80 is a convex-piano lens, and thus a central portion of the third outward facing surface 82 is outwardly convex, and the third inward facing surface 84 is planar. The radius of curvature of the third outward facing surface 82 is less than the radius of curvature of the second inward facing surface 74, whereby a space 78 exists between these curved surfaces.

The fourth lens 90 is disposed in the lens housing 32 adjacent to the third lens 80. The fourth lens 90 includes a fourth outward facing surface 92 that faces and abuts the third inward facing surface 84, a fourth inward facing surface 94 that is spaced apart from the fourth outward facing surface 92, and a fourth peripheral edge 96 that extends between the fourth outward facing surface 92 and the fourth inward facing surface 94. The fourth lens 90 is a flat lens, and thus the fourth outward facing surface 92 and the fourth inward facing surface 94 are each planar.

The fifth lens 100 is disposed in the lens housing 32 adjacent to the fourth lens 90. The fifth lens 100 includes a fifth outward facing surface 102 that faces and abuts the fourth inward facing surface 94, a fifth inward facing surface 104 that is spaced apart from the fifth outward facing surface 102, and a fifth peripheral edge 106 that extends between the fifth outward facing surface 102 and the fifth inward facing surface 104. The fifth lens 100 is a piano-convex lens, and thus the fifth outward facing surface 102 is planar, and a central portion of the fifth inward facing surface 104 is inwardly convex.

The camera 1 includes sealing features that reduce the amount of moisture that can enter the camera body and thus minimize moisture condensation within the lens assembly 50. The sealing features include an annular first housing seal 140 disposed between the first lens first peripheral edge 66 and an inner surface of the lens housing 32. The first housing seal 140 prevents moisture from entering the camera housing 2 via a path that extends between the lens stack 50 and the lens housing 32. Placement of the first housing seal 140 outward relative to the first inward facing surface 64 of the first (outermost) lens 60 minimizes exposure of this surface to external moisture.

In addition, an annular second housing seal 142 is disposed between an outer surface of the shoulder 40 and the collar 60. Along with the first housing seal 140, the second housing seal 142 prevents external moisture from entering the camera housing 2 via a path between the lens housing 32 and the collar 6.

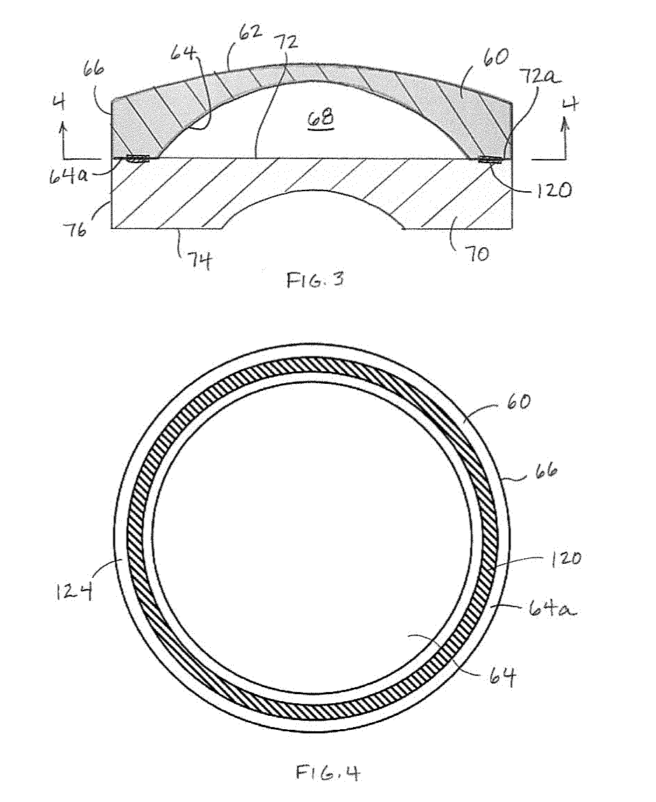

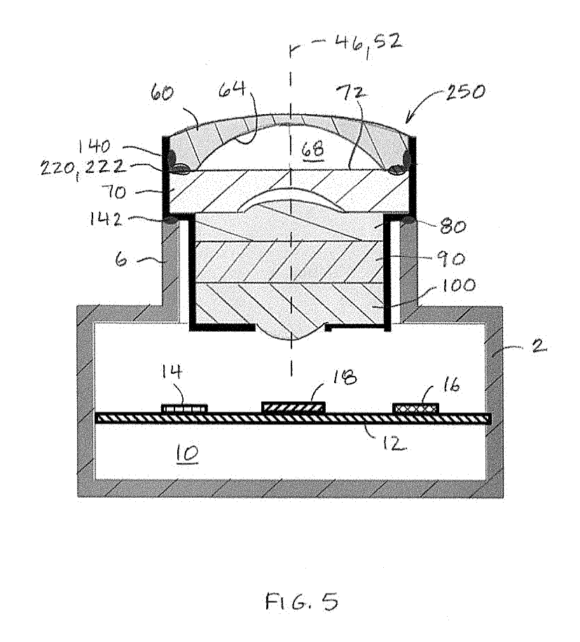

Referring also to FIGS. 3 and 4, the sealing features further include a lens seal 120 that is disposed between the first lens 60 and the second lens 70. In particular, a peripheral portion 72a of the second outward facing surface 72 abuts a peripheral portion 64a of the first inward facing surface 64 so as to form an annular region of contact 124 between the first lens 60 and the second lens 70. The lens seal 120 is a fusion of the first lens 60 with the second lens 70 along the annular region of contact 124. Fusion between the contacting surfaces of the first and second lenses 60, 70 can be achieved by, for example, laser welding. Fusion can be performed in normal atmospheric conditions, or alternatively can be performed in a noble gas environment to eliminate the presence of moisture within the space 68.

Placement of the lens seal 120 at a location between the contacting surfaces of the first and second lenses 60, 70 prevents moisture, such as may exist within the camera housing 2 or may permeate through the walls of the camera housing 2 or lens housing 32, from entering the space 68. Placement of the lens seal 120 at this location also reduces the size of the space 68 relative to some conventional lens assemblies, whereby moisture within the space 68 available for condensation is also reduced. Finally, placement of the lens seal 120 at this location shifts the location of possible condensation to the space 78 between the second lens 70 and the third lens 80. However, since this location is isolated from contact with the external environment by the presence of the first lens 60 and the first housing seal 140, generation of condensation on the inward facing surface 74 of the second lens 70 is made difficult.

In the embodiment illustrated in FIGS. 2-4, at least the first and second lenses 60, 70 are formed of the same material (for example, glass) so that these lenses can be reliably fused together along the region of contact. In addition, providing the first (outermost) lens 60 as a glass lens provides scratch resistance during use.

Referring to FIG. 5, an alternative embodiment lens seal 220 is contemplated for lens assemblies 250 in which one or both of the first and second lenses 60, 70 are not formed of the same material and/or are not both formed of glass. For example, one or both of the first and second lenses 60, 70 may be formed of plastic. In this example, the lens seal 220 is provided by an annular gasket 222 disposed between facing surfaces 64, 72 of the first and second lenses 60, 70. Placement of the lens seal 220 between the facing surfaces 64, 72 of the first and second lenses 60, 70 provides a confined space 68 in which the only moisture available for generating condensation is located within the space 68.

In the illustrated embodiments, the lens stack 50 includes five individual lenses 60, 70, 80, 90, 100 in a stacked arrangement. It is understood that the lens stack 50 may include a greater or fewer number of lenses than shown in the illustrated embodiments, and that use of multiple lenses increases image quality of the image detected via the lenses. It is further understood that the number of lenses included in the stack is determined by the requirements of the specific application.

Although each lens 60, 70, 80, 90, 100 has been described as having a particular shape and/or orientation or ordering within the stack, the lenses 60, 70, 80, 90, 100 are not limited to the described arrangement. Rather the selection of shapes of the lenses, the orientation and the ordering of the lenses within the lens stack can vary. In addition, the longitudinal spacing of the lenses within the lens stack can be altered so that gaps exist between one or more pairs of adjacent lenses. The selection of particular lenses and arrangment of lenses is determined by the requirements of the specific application.

Selective illustrative embodiments of the camera lens assembly and camera system are described above in some detail. It should be understood that only structures considered necessary for clarifying the assembly and system have been described herein. Other conventional structures, and those of ancillary and auxiliary components of the assembly and system, are assumed to be known and understood by those skilled in the art. Moreover, while a working example of the assembly and system have been described above, the assembly and system are not limited to the working examples described above, but various design alterations may be carried out without departing from the assembly and system as set forth in the claims.

What is claimed, is:

1. A camera lens assembly comprising
a lens housing having an open end;
a lens stack disposed in the lens housing, the lens stack including
a first lens disposed in the lens housing open end, the first lens providing an outermost lens of the lens stack, the first lens comprising a first outward facing surface, a first inward facing surface that is spaced apart from the first outward facing surface, and a first peripheral edge that extends between the first outward facing surface and the first inward facing surface; and
a second lens disposed in the lens housing, the second lens comprising a second outward facing surface, a second inward facing surface that is spaced apart from the second outward facing surface, and a second peripheral edge that extends between the second outward facing surface and the second inward facing surface, the second outward facing surface facing the first inward facing surface; and
a lens seal disposed between the second outward facing surface and the first inward facing surface.

2. The camera lens assembly of claim 1, wherein
a portion of the second outward facing surface abuts a portion of the first inward facing surface so as to form an annular region of contact between the first lens and the second lens; and
the lens seal is a fusion of the first lens with the second lens along the annular region of contact.

3. The camera lens assembly of claim 1, wherein the lens seal is an annular gasket disposed between the first lens and the second lens.

4. The camera lens assembly of claim 1, comprising a first annular housing seal disposed between the first peripheral edge and an inner surface of the lens housing.

5. The camera lens assembly of claim 1, wherein the lens housing comprises
a first end that defines the open end,
a second end opposed to the first end, and
a non-uniform inner diameter such that a shoulder is disposed between the first end and the second end,
wherein
the second inward facing surface is supported on the shoulder, and
the first annular housing seal is disposed between the first peripheral edge and an inner surface of the lens housing at a location between the first end and the shoulder.

6. The camera lens assembly of claim 1 wherein the lens stack includes n lenses, where n is a positive integer have a value of at least four.

7. The camera lens assembly of claim 1, wherein
the first inward facing surface is convex, the second outward facing surface is planar, and
a first sealed space exists between the first inward facing surface, the lens seal, and the second outward facing surface.

8. The camera lens assembly of claim 1, wherein the first lens and the second lens are each formed of glass.

9. The camera lens assembly of claim 1, wherein the first lens is formed of glass and the second lens is formed of plastic.

10. A camera comprising;
a camera housing having an opening;
a lens stack disposed in the opening; the lens stack comprising
a first lens providing an outermost lens of the lens stack, the first lens comprising a first outward facing surface, a first inward facing surface spaced apart from the first outward facing surface, and a first peripheral edge that extends between the first outward facing surface and the first inward facing surface; and
a second lens comprising a second outward facing surface, a second inward facing surface spaced apart from the second outward facing surface, and a second peripheral edge that extends between the second outward facing surface and the second inward facing surface, the second outward facing surface facing the first inward facing surface;
an annular housing seal disposed between the first lens and the camera housing; and
a lens seal disposed between the second outward facing surface and the first inward facing surface.

11. The camera of claim 10, wherein
a portion of the second outward facing surface abuts a portion of the first inward facing surface so as to form an annular region of contact between the first lens and the second lens; and
the lens seal is a fusion of the first lens with the second lens along the annular region of contact.

12. The camera of claim 10, wherein the lens seal is an annular gasket disposed between the first lens and the second lens.

13. The camera of claim 10, comprising a lens housing disposed in the opening and protruding outward from the camera housing; wherein
the lens stack is disposed in the lens housing with the first outward facing surface disposed in an open end of the lens housing.

14. The camera of claim 13, wherein the annular housing seal is disposed between the first peripheral edge and an inner surface of the lens housing.

15. The camera of claim 13, wherein the lens housing comprises
a first end that defines the open end,
a second end opposed to the first end, and
a non-uniform inner diameter such that a shoulder is disposed between the first end and the second end,
wherein
the second inward facing surface is supported on the shoulder,
the annular housing seal is disposed between the first peripheral edge and an inner surface of the lens housing at a location between the first end and the shoulder, and
a second annular housing seal is disposed between the shoulder and the camera housing.

16. The camera of claim 10 wherein the lens stack includes n lenses, where n is a positive integer have a value of at least four.

17. The camera of claim 10 wherein the first lens and the second lens are each formed of glass.

18. The camera of claim 10 wherein the first lens is formed of glass and the second lens is formed of plastic.
